(19) United States
(12) Patent Application Publication
(10) Pub. No.: US 2005/0100338 A1
(43) Pub. Date: May 12, 2005

(54) Two-dimensional wavelength/time optical CDMA system adopting balanced-modified pseudo random noise matrix codes

(76) Inventors: Younghee Yeon, Kangwon-do (KR); Bong Kyu Kim, Daejeon-city (KR); Sung Chan Cho, Daejeon-city (KR); Sang Jo Park, Chungcheongbuk-do (KR); Byoung Whi Kim, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/864,561

(22) Filed: Jun. 8, 2004

(30) Foreign Application Priority Data
Nov. 11, 2003 (KR) 2003-79603

(51) Int. Cl. H04J 4/00

(52) U.S. Cl. 398/78

(57) ABSTRACT

A two-dimensional wavelength/time optical CDMA system employing balanced-modified pseudo random noise (PN) matrix codes is provided. Through an inverse-exclusive OR operation of a pair of modified PN code, the balanced codes are generated as optical CDMA codes in the form of a new matrix. When the codes are applied to an optical CDMA system to perform encoding and decoding, if the same number of channels as the number (M−1) of subgroups of the codes are connected, the system becomes an MAI-free system, and even if the number of channels connected is twice the number of the subgroups, an error-free system can be established. Accordingly, the number of channels that can be used simultaneously is doubled compared to the prior art method such that the economical efficiency of the optical CDMA system improves.

This application claims the priority of Korean Patent Application No. 2003-79603, filed on Nov. 11, 2003, in the Korean Intellectual Property Office, the disclosure of which is incorporated herein in its entirety by reference.

### BACKGROUND OF THE INVENTION

1. Field of the Invention

The present invention relates to an optical communication system, and more particularly, to a two-dimensional wavelength/time optical code division multiple access (OCDMA) system.

2. Description of the Related Art

An optical code division multiple access (OCDMA) system is a method for transmitting information by which a unique code is given to each user, and is generated and interpreted in an optical area so that a plurality of users can simultaneously use a network. Like the conventional RF-CDMA technology, the OCDMA allocates bandwidths to more users such that bandwidths can be used more efficiently and has a good security characteristic. In addition, the OCDMA has a characteristic enabling users to use a network independently to each other and asynchronously.

The entire performance of an OCDM system can be said to be totally dependent on codes allocated to respective users and therefore many research projects have been performed for the codes.

A temporal/wavelength two-dimensional code which has been reported recently has a better performance than that of the prior art code structure in the aspect of the number of simultaneous users allowable in a given bit error rate (BER). Also, with its efficient use of time and wavelength dimensions, it shows a noteworthy expansibility in designing codes.

However, the two-dimensional wavelength/time optical CDMA code that has been proposed so far is the one that can be applied to a direct detection method using one optical diode and a single-pulse-per-row matrix code that is built assuming correspondence of one pulse on a code so that interference by simultaneous users can be reduced as possible. Accordingly, there is a problem that when a BER generated by simultaneous users is calculated, a non-zero BER limit by multiple-access interference (MAI) exists.

### SUMMARY OF THE INVENTION

The present invention provides a two-dimensional wavelength/time optical CDMA system adopting balanced-modified pseudo random noise (PN) matrix codes.

According to an aspect of the present invention, there is provided a two-dimensional wavelength/time optical code-division multiple access (CDMA) system, adopting balanced-modified PN matrix codes which are divided into a plurality of subgroups according to a wavelength hopping pattern and in which each of the subgroups comprises a plurality of two-dimensional balanced-modified PN matrix codes, and in each of the matrix codes, each row vector indicates a time domain encryption pattern and each column vector indicates a wavelength domain encryption pattern, wherein each element of the balanced PN matrix codes is calculated by performing an inverse-exclusive OR operation of a pair of a first modified PN code with a length of N and a second modified PN code with a length of M, and a chip-time-shift version of the pair.

According to another aspect of the present invention, there is provided an encoding apparatus of a two-dimensional wavelength/time optical CDMA system adopting balanced-modified PN matrix codes, the encoding apparatus comprising: at least two or more optical modulation units which in response to an optical signal, modulate balanced-modified PN matrix codes into on-off pulses; at least two or more optical filtering units which reflect the on-off pulses received from the optical modulation units by wavelength and encrypt into a wavelength located in a predetermined chip time; and at least two or more optical circulators which are connected to the optical modulation units and the optical filtering units, and perform a wavelength/time selection function for the on-off pulses.

According to still another aspect of the present invention, there is provided a decoding apparatus of a two-dimensional wavelength/time optical CDMA system adopting balanced-modified PN matrix codes, the decoding apparatus comprising: a wavelength multiplexing unit which multiplexes encoded balanced-modified PN matrix codes by wavelength; a delay unit which delays the codes multiplexed by wavelength, for a predetermined time period; and a photo detecting unit which performs differential detection or balanced detection for the optical power of the codes input from the delay unit, and decodes the codes into the original balanced-modified PN matrix code before the encoding.

According to yet still another aspect of the present invention, there is provided a decoding apparatus of a two-dimensional wavelength/time optical CDMA system adopting balanced-modified PN matrix codes, the decoding apparatus comprising: a first and second optical filtering units that multiplex encoded balanced-modified PN matrix codes by wavelength; a first and second circulators that are connected to the first and second optical filtering units and performs a wavelength/time selection function for the codes; and a photo detecting unit which performs differential detection or balanced detection for the optical power of the codes input from the first and second optical filtering units, and decodes the codes into the original balanced-modified PN matrix code before the encoding.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram showing one-dimensional PN codes and modified PN (mPN) codes;

FIG. 2 is a diagram showing a balanced-modified PN matrix codes according to a preferred embodiment of the present invention;

FIG. 3 is a diagram showing a simplified structure of an encoder to which balanced-modified PN matrix codes according to a preferred embodiment of the present invention;

FIG. 4 is a diagram showing a simplified structure of a decoder to which balanced-modified PN matrix codes according to a preferred embodiment of the present invention;

FIG. 5A is a diagram showing a simplified structure of a decoder according to another preferred embodiment of the present invention, to which balanced-modified PN matrix codes;

FIG. 5B is diagram showing a structure of decoder according to another preferred embodiment of the present invention;

FIG. 6 is a diagram showing a correlation pattern immediately before a signal which is encrypted with a balanced-modified PN matrix code C₁₁ and passes through a decoder for C₁₁ shown in FIGS. 4 and 5 is input to a photo detecting unit;

FIG. 7 is a diagram showing a correlation pattern of code C₂₁ in relation to C₁₁ decoder which decodes balanced-modified PN matrix code C₁₁; and

FIG. 8 is a diagram showing correlation patterns of twenty-one decoded balanced-modified PN matrix codes.

### DESCRIPTION OF THE PREFERRED EMBODIMENTS

Hereinafter, the present invention will be described in detail by explaining preferred embodiments of the invention with reference to the attached drawings.

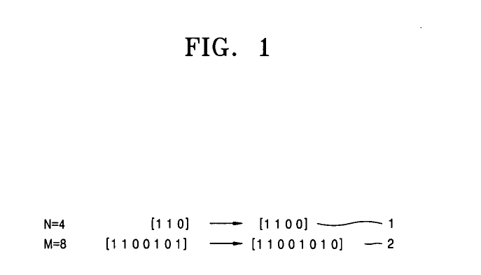

FIG. 1 is a diagram showing one-dimensional PN codes and a modified PN (mPN) codes. Referring to FIG. 1, mPN codes 1 and 2 are generated from PN codes and the lengths are N=4 and M=8.

In order to encrypt a wavelength domain and a time domain, respectively, two independent mPN codes are selected. The conventional PN codes which are mainly used to distinguish mobile stations (terminals) have a characteristic that the difference of the numbers of 1's and 0's is always 1. Meanwhile, mPN codes are formed so that the numbers of 1's and 0's are identical. That is, as shown in FIG. 1, by adding stuff chip ‘0’ in an arbitrary location of a PN code so as to make the numbers of 1's and 0's identical, an mPN code is formed. At this time, the location of the added stuff chip does not matter but the stuff chip should be added to an identical location (that is, identical column) in all channel codes. The structure of balanced-modified PN matrix codes according to the present invention generated by using these mPN codes will now be explained.

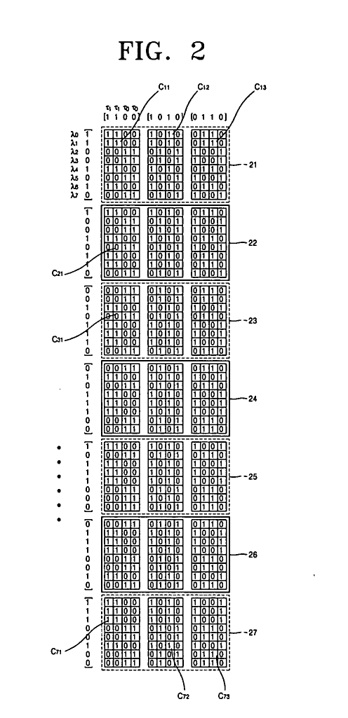

FIG. 2 is a diagram showing a balanced-modified PN matrix codes according to a preferred embodiment of the present invention.

Referring to FIG. 2, each row vector forming one of matrices indicates a time domain encryption pattern, while each column vector indicates a wavelength domain encryption pattern.

The elements of the balanced-modified PN matrix codes shown in FIG. 2 are twenty-one matrices, each of which is obtained by performing inverse-exclusive OR operation of a pair of mPN codes having lengths of M=8 and N=4, respectively, and a chip-time-shift version of the pair.

The twenty-one codes are divided into seven subgroups 21 through 27 according to a wavelength hopping pattern, and codes belonging to an identical subgroup show an identical wavelength-hopping pattern. For example, in the first subgroup 21, each chip is encoded by using wavelength [λ₀, λ₁, λ₄, λ₆], or its complementary wavelength [λ₂, λ₃, λ₅, λ₇], and in the second subgroup 22, a signal is transmitted by using wavelength [λ₀, λ₃, λ₅, λ₆] and its complementary wavelength [λ₁, λ₂, λ₄, λ₇]. That is, the first subgroup 21 selects wavelength [λ₀, λ₁, λ₄, λ₆] according to the wavelength pattern of mPN code [1 1 0 0 1 0 1 0], while in the second subgroup 22, the signal is transmitted by using wavelength [λ₀, λ₃, λ₅, λ₆] according to the wavelength pattern of [1 0 0 1 0 1 1 0].

Meanwhile, code members belonging to an identical subgroup are distinguished by different chip-time-shift versions. Here, code Cᵢⱼ denotes the j-th code among codes belonging to subgroup i among (M−1) subgroups having (N−1) chip-time-shift versions. This algorithm generates a total of (M−1)×(N−1) balanced-modified PN matrix codes.

Any one of the twenty-one generated balanced-modified PN matrix codes has a characteristic that it does not cause interference with codes belonging to other subgroups.

Accordingly, if an optical CDMA system is formed with codes belonging to different subgroups (for example, C₁₁, C₂₁) among the balanced-modified PN matrix codes, then the system will have no interference at all between channels.

Also, in the balanced-modified PN matrix codes according to the present invention, if two codes having less interference between codes are selected among codes belonging to each subgroup and decoding is performed in the reception end by using a threshold, though there will be interference by simultaneous users, errors will not occur. Accordingly, when the same number of codes as twice the number of subgroups are used, an error-free system can be constructed.

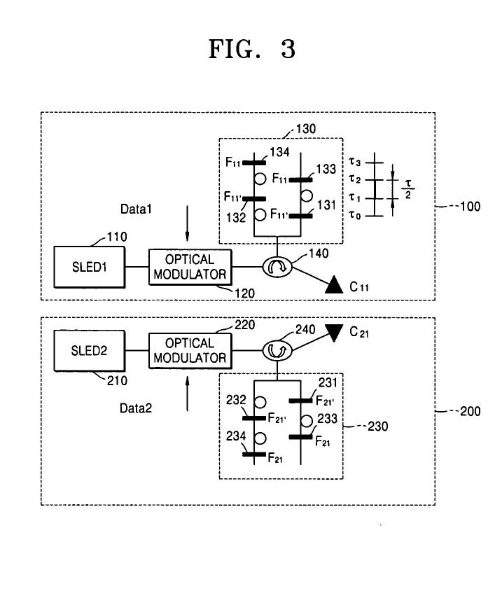

FIG. 3 is a diagram showing a simplified structure of an encoder to which balanced-modified PN matrix codes according to a preferred embodiment of the present invention.

Referring to FIG. 3, the encoder according to the present invention comprises a first encoding unit 100 and a second encoding unit 200 having an identical circuit structure. The first encoding unit 100 is used to encode C₁₁ pattern (refer to balanced-modified PN matrix codes of FIG. 2), and the second encoding unit 200 is used to encode C₂₁ pattern (refer to balanced-modified PN matrix codes of FIG. 2).

The first encoding unit 100 comprises a light source 110, an optical modulator 120, an optical filtering unit 130 and an optical circulator 140. The light source 110 is formed with a superluminescent LED (SLED), which is a kind of broadband light source, and is used as a light source for optical modulation. In response to data (DATA1, for example C₁₁ code) generated by a data generation unit (not shown) and an optical signal generated by the light source 110, the optical modulator 120 performs optical modulation and generates on-off pulses. The optical filtering unit 130 can be implemented by a fiber Bragg grating, and is constructed reflecting time delay effects. The optical filtering unit 130 reflects on-off pulses output from the optical modulator 120 by wavelength, and encrypts each pulse into a wavelength located in predetermined chip time. The optical circulator 140 is connected to the optical modulator 120 and the optical filtering unit 130 and performs a wavelength/time selection function for on-off pulses generated by the optical modulator 120. As a result, light radiated from the light source 110 is converted into on-off pulses by the optical modulator 120 according to the signal (DATA1) of the data generator, and while passing through the optical filtering unit 130 and the optical circulator 140, is encrypted into a wavelength located in a predetermined chip time.

The optical filtering unit 130 includes four optical filters 131 through 134. In order to generate a pulse corresponding to respective chip times, τ₀τ₁, τ₂, τ₃, the optical filtering unit 130 arranges the optical filters 131 through 134 at time delay intervals of τ/2.

The first and second optical filters 131 and 132 indicated by F₁₁′ reflect corresponding wavelengths [λ₂, λ₃, λ₅, λ₇], and the third and fourth filters 133 and 134 indicated by F₁₁ reflect wavelengths [λ₀, λ₁, λ₄, λ₆] that are complementary to the wavelengths reflected by the first and second optical filters 131 and 132. The index (i=1, j=1) in Fᵢⱼ represent filter for code Cᵢⱼ. More specifically, the first optical filter 131 reflects wavelength [λ₂, λ₃, λ₅, λ₇] at chip time τ₀, the second optical filter 132 reflects wavelength [λ₂, λ₃, λ₅, λ₇] at chip time τ₀, the third optical filter 133 reflects wavelength [λ₀, λ₁, λ₄, λ₆] at chip time τ₂, and the fourth optical filter 134 reflects wavelength [λ₀, λ₁, λ₄, λ₆] at chip time τ₃. This structure of the optical filtering unit 130 makes optical outputs completely balanced such that interference is removed.

In FIG. 3, the second encoding unit 200 has the same circuit structure as that of the first encoding unit 100 and the only difference is that the second encoding unit 200 encodes signal C₂₁. Accordingly, to avoid redundant explanation, detailed explanation of the structure of the second encoding unit 200 will be omitted.

In FIG. 3, only the structures of the two encoding units 100 and 200 are shown, but with respect to the number of users, the number of encoding units increases. In particular, in the balanced-modified PN matrix codes according to the present invention, when two codes having less interference are selected from codes belonging to each subgroup and are encoded, and then by using a threshold in the reception end, data is decoded, an error does not occur in the decoding result as when codes belonging to different subgroups are used. Accordingly, an encoding unit can be formed using a number of codes that is twice the number of subgroups.

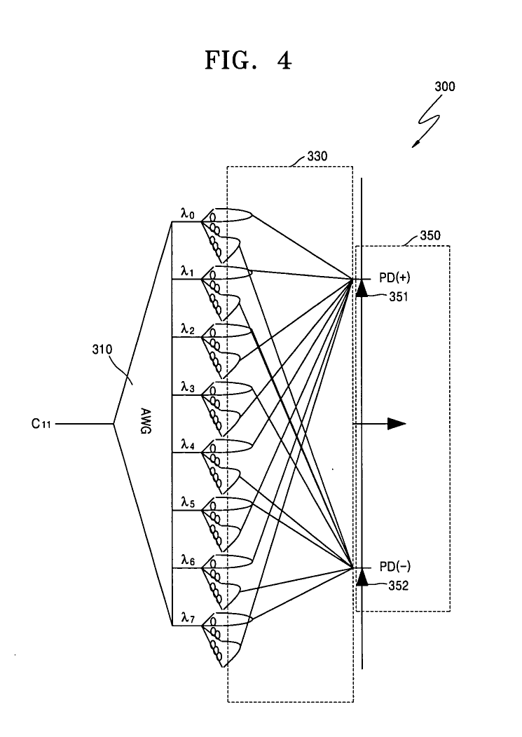

FIG. 4 is a diagram showing a simplified structure of a decoder to which balanced-modified PN matrix codes according to a preferred embodiment of the present invention. FIG. 4 shows the structure of a decoder which decodes C₁₁ balanced-modified PN matrix code.

Referring to FIG. 4, the decoder 300 according to the present invention comprises a wavelength multiplexing unit 310, a time delay unit 330, and a photo detecting unit 350. The wavelength multiplexing unit 310 is formed with an arrayed-waveguide grating (AWG) and performs a role multiplexing an input signal by wavelength. The time delay unit 330 is formed with a plurality of time delay lines connected between the wavelength multiplexing unit 310 and the photo detecting unit 350 and performs a role delaying a plurality of signals, which are divided by wavelength, for a predetermined time period. The photo detecting unit 350 comprises a first photo detector (PD(+)) 351 and a second photo detector (PD(−)) 352 that perform differential detection or complementary balanced detection, and detects a signal based on the difference of signals detected by the two photo detectors 351 and 352.

A signal received by the decoder 300 is divided by wavelength when passing through the wavelength multiplexing unit 310, and a divided signal for each wavelength is input to the time delay unit 330 so as to pass through time delays corresponding to τ₀, τ₁, τ₂, τ₃.

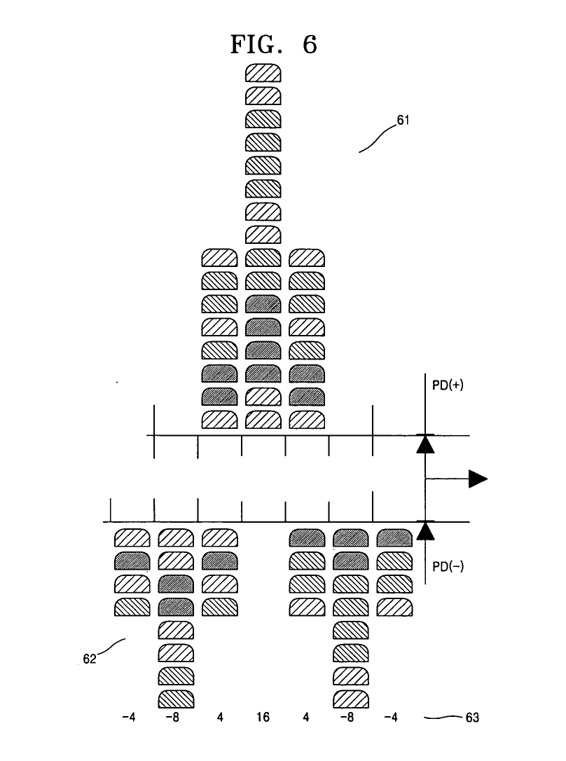

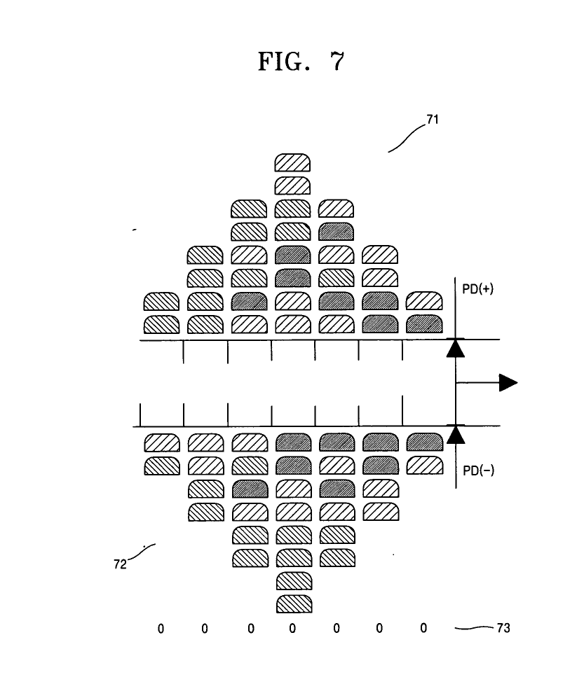

The decoder 300 arranges time delay lines according to an allocated code (for example, C₁₁). For example, a time delay line corresponding to ‘1’ (‘1’ located on m-th wavelength, and n-th time-chip) is connected to the first photo detector 351 and a time delay line corresponding to ‘0’ is connected to the second photo detector 352. Pulses corresponding to user's own code among pulse data passing through respective time delay lines pass through a correlation process and then are detected by the two photo detectors 351 and 352. At this time, the result of differential operation by the two photo detectors 351 and 352 exceeds a predetermined threshold such that with the decoder being in on-state, data is output, while pulses corresponding to other users' codes are input symmetrically to the two photo detectors 351 and 352 in time domain such that the decoder is in off-state. In this case, optical outputs of the first and second photo detectors 351 and 352 are completely balanced such that interference by simultaneous users does not occur. This decoding result of the decoder will be explained later in detail referring to FIGS. 6 and 7.

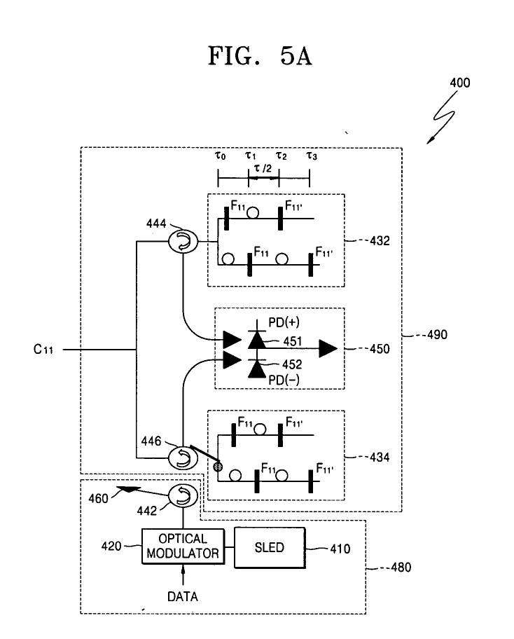

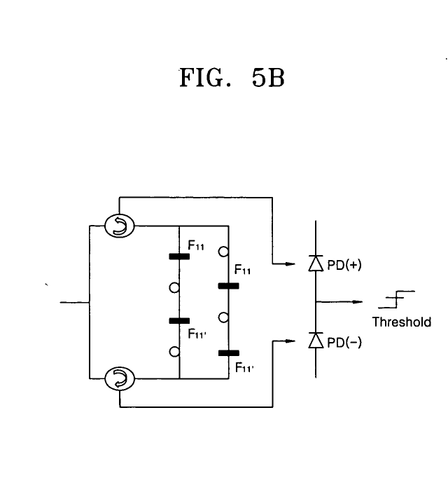

FIG. 5A is a diagram showing a simplified structure of a decoder according to another preferred embodiment of the present invention, to which balanced-modified PN matrix codes. The decoder 400 shown in FIG. 5A uses a plurality of optical filters reflecting calculation of time delay, instead of using the AWG and time delay lines of the decoder 300 of FIG. 4. The decoder 400 broadly comprises an encoding unit 480 and a decoding unit 490 and according to the switching operation of a switch 460, selectively performs an encoding function and a decoding function. First, the structure of the decoding unit 490 will now be explained.

The decoding unit 490 comprises a first and second optical filtering unit 432 and 434, a first and second circulators 444 and 446, and a photo detecting unit 450. The first and second optical filtering units 432 and 434 can be implemented by a fiber Bragg grating and each unit has a complementary filter structure having four optical filters. The first and second optical filtering units 432 and 434 arranges the optical filters at time delay intervals of τ/2 so that input codes can be recognized as pulses corresponding to chip times τ₀, τ₁, τ₂, τ₃. The photo detecting unit 450 comprises a first photo detector (PD(+)) 451 and a second photo detector (PD(−)) 452 that perform differential detection or complementary balanced detection, and detects a signal based on the difference of signals detected by the two photo detectors 451 and 452.

Circulators 444 and 446 select wavelength/time according to a code (for example, C11) allocated to the decoder 300 and the optical filtering unit 432 and 434 multiplex an input signal by wavelength. The signal multiplexed through the circulators 444 and 446 and the optical filtering unit 432 and 434 is input to the photo detecting unit 450 and is decoded into the original balanced-modified PN matrix code. At this time, pulses corresponding to the user's own codes among the pulses received by the decoder 400 have differential results exceeding a threshold such that the pulses are decoded in on-state, while pulses corresponding to other users' codes are symmetrically input in time domain to the two photo detectors 451 and 452 such that the pulses are decoded in off-state. Thus, the decoder 400 according to the present invention detects optical power by performing differential detection or balanced detection by using the two photo detectors 451 and 452 such that multiple-access interference (MAI) caused by multiple access is removed. In this case, by adjusting a threshold, the same number of error-free systems as twice the number (M−1) of subgroups can be constructed such that a channel with an error-free characteristic twice stronger than the prior art can be used.

Next, the structure of the encoding unit 480 will now be explained. The encoding unit 480 comprises a light source 410, an optical modulator 420, an optical circulator 442, and a switch 460. The light source 110 is formed with an SLED, which is a kind of broadband light source as the encoder shown in FIG. 3, and is used as a light source for optical modulation. The optical modulator 420 performs optical modulation in response to data generated by a data generation unit (not shown) and an optical signal generated by the light source 410, and generates on-off pulses.

In order for the encoding unit 480 to perform encoding, an optical filter is needed, and for encoding operation, the encoding unit shares the second optical filtering unit 434 disposed in the decoding unit 490. That is, by switching operation of the switch 460, the second optical filtering unit 434 is selectively connected to the encoding unit 480 or the decoding unit 490 and performs optical filtering for encoding or decoding.

Thus, by sharing a part (that is, the optical filtering unit) forming the decoder 400 with the filter structure of the encoder, the decoder 400 according to the present invention can encrypt a signal without a separate encoder.

FIG. 5B illustrates a structure of balanced decoder C₁₁. Decoding part consists of optical couplers, optical circulators, optical filters, optical delay lines, and two photodiodes. The optical coupler splits the transmitted lights. The split lights are input to the filter arrays which are constructed by the filters F₁₁ and F₁₁′, which are same as used in the encoder for C₁₁. But the other end of the filter arrays is linked to another circulator. The upper and lower circulators hold the filter arrays in common, but generate reflection in reverse order.

After the transmitted optical signals are reflected in the opposite direction from the filter arrays, they have different delay times, which are complimentary to each other, that is, they are decoded by code C₁₁ (by upper arm) and its complimentary code \overline{C₁₁} (by lower arm). Then, the light arrive at the two photodiodes PD(+) and PD(−), respectively. By detecting the subtracted currents between those, the desired signal can be extracted. And finally the extracted electrical signal is determined as “on” or “off” according to the fact of whether or not it goes over the pre-assigned threshold level.

FIG. 5B has an identical function as of FIG. 5A, but has a simpler filter array than FIG. 4 or 5A, in fact the number of filter arrays is decreased to half in size. Hence FIG. 5B is a more appropriate decoder structure. The index (i=1, j=1) in Fᵢⱼ represent filter for code Cᵢⱼ.

FIG. 6 is a diagram showing a correlation pattern immediately before a signal which is encrypted with a balanced-modified PN matrix code C₁₁ and passes through a decoder for C₁₁ shown in FIGS. 4 and 5 is input to a photo detecting unit, and FIG. 7 is a diagram showing a correlation pattern of code C₂₁ in relation to C₁₁ decoder which decodes balanced-modified PN matrix code C₁₁.

FIG. 6 shows optical power input to a photo detector when a signal encrypted with an identical code arrives (that is, when a pulse corresponding to the user's own code arrives), and FIG. 7 shows optical power input to a photo detector when a signal encrypted with a different code arrives (that is, when a pulse corresponding to another user's code arrives).

In FIGS. 6 and 7, each of signals decoded by the decoder 300 or 400 is spread as a pulse along (2N−1) chip times, and as the signal is nearer to the photo detecting unit (that is, the two photo detectors PD(+), PD(−)), it means that the signal arrives earlier. In the two patterns shown in FIGS. 6 and 7, by setting a threshold immediately below a maximum peak value of the output of the differential result of the photo detector, information bit ‘1’ can be extracted.

Reference number 61 in FIG. 6 indicates a detection pattern by the first photo detector (PD(+)) and reference number 62 indicates a detection pattern by the second photo detector (PD(−)). Reference number 63 indicates the result of decoding after the signal encrypted with code C₁₁ passes through the decoder 300 or 400.

Likewise, reference number 71 in FIG. 7 indicates a detection pattern by the first photo detector (PD(+)) and reference number 72 indicates a detection pattern by the second photo detector (PD(−)). Reference number 73 indicates the result of decoding after the signal encrypted with code C₂₁ passes through the decoder 300 or 400 designed for code C₁₁. A code showing the pattern indicated by reference number 73 in relation to decoder Cᵢⱼ means an arbitrary code Cₖₗ (k≠i).

In the two patterns shown in FIGS. 6 and 7, by setting a threshold immediately before a maximum peak value, information bit ‘1’ can be extracted. Accordingly, it can be seen that when a signal encrypted with an identical code as shown in FIG. 6 arrives (that is, when a pulse corresponding to the user's own code arrives), the signal is decoded into the original signal (reference number 63), but the signal encrypted with a code belonging to other subgroups as shown in FIG. 7 is completely canceled by the symmetry of the decoder structure such that interference does not occur.

Therefore, in a two-dimensional wavelength/time optical CDMA, if (M−1) codes Cₖₗ (k≠i) belonging to subgroups different to each other among (M−1)×(N−1) balanced mPN matrix codes are applied to the optical CDMA system and the encoding and decoding are performed, an optical CDMA network without interference between users can be constructed. Also, even in an identical subgroup, if two codes having less code interference are selected and data is decoded by using a threshold in a reception end, an error does not occur. Accordingly, by using the same number of codes as twice the number of subgroups, an error-free system can be constructed.

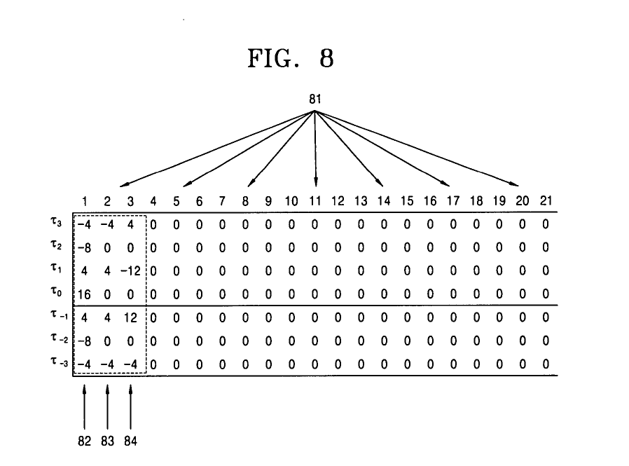

FIG. 8 is a diagram showing correlation patterns of twenty-one decoded balanced-modified PN matrix codes, and shows the result of calculation by MATLAB of a U.S. company, Mathwork. FIG. 8 shows the correlation pattern calculated after encoding signals for twenty-one balanced-modified PN matrix codes including user's own code (for example, C₁₁) are input to the decoder 300 and 400 shown in FIGS. 4 and 5.

The twenty-one balanced-modified PN matrix codes can be divided into seven subgroups (refer to 21 through 27 of FIG. 2) by wavelength hopping pattern. As indicated by reference numbers 82 through 84 in FIG. 8, interference occurred only by a user of codes (for example, C₁₁, C₁₂, C₁₃) belonging to an identical subgroup (refer to the part indicated by dotted lines). Accordingly, in order to build an MAI-free system by using a total of twenty-one balanced-modified PN matrix codes, one for each subgroup (seven in total) can be selected and used. However, if in the first subgroup (refer to reference number 21 of FIG. 2), C₁₁ and C₁₂ corresponding to reference numbers 82 and 83 are simultaneously used and a threshold is set to 12, then two codes can be used in each subgroup such that a total of 14 error-free systems can be built. At this time, the C₁₁ code user and the C₁₂ code user are not affected by number (for example, −4) interfering to each other.

Accordingly, if the balanced-modified PN codes according to the present invention are used, an error-free system capable of accommodating the same number of subscribers as twice the number (M−1) of subgroups can be built. As a result, the number of channels that can be used simultaneously is doubled compared to the prior art method such that the economical efficiency of the optical CDMA system improves and utilization of optical networks, including banking networks and defense networks that need higher security, increases.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

As described above, the balanced-modified pseudo random noise (PN) matrix codes that can be applied to a two-dimensional wavelength/time optical CDMA system according to the present invention can be easily generated by using PN codes that are used in wireless communications.

Also, when encoding and decoding are performed by applying the two-dimensional balanced-modified PN codes according to the present invention, an error-free system can be established even when the number of channels connected is twice the number (M−1) of the subgroups, as well as when the same number of channels as the number (M−1) of subgroups are connected. Accordingly, the number of channels that can be used simultaneously is doubled compared to the prior art method such that the economical efficiency of the optical CDMA system improves.

1. A two-dimensional wavelength/time optical code division multiple access (CDMA) system, adopting balanced-modified pseudo random noise (PN) matrix codes which are divided into a plurality of subgroups according to a wavelength hopping pattern and in which each of the subgroups comprises a plurality of two-dimensional balanced-modified PN matrix codes, and in each of the matrix codes, each row vector indicates a time domain encryption pattern and each column vector indicates a wavelength domain encryption pattern,
wherein each element of the balanced PN matrix codes is calculated by performing an inverse-exclusive OR operation of a pair of a first modified PN code with a length of M and a second modified PN code with a length of N, and a chip-time-shift version of the pair.

2. The system of claim 1, wherein when the length of the first modified PN code is M and the length of the second modified PN code is N, the optical CDMA system generates a total of (M−1)×(N−1) balanced-modified PN matrix codes.

3. The system of claim 1, wherein the optical CDMA system performs encoding and decoding by using at least two ore more codes belonging to different subgroups of the plurality of balanced-modified PN matrix codes.

4. The system of claim 1, wherein the optical CDMA system selects two balanced-modified PN matrix codes having less interference among the plurality of balanced-modified PN matrix codes belonging to each of the subgroups, and performs decoding by using a predetermined threshold in a reception end.

5. The system of claim 1, wherein the first and second modified PN codes are generated by adding stuff chip 0 in a random position so that the number of 1's is the same as the number of 0's.

6. An encoding apparatus of a two-dimensional wavelength/time optical CDMA system adopting balanced-modified PN matrix codes, the encoding apparatus comprising:
at least two or more optical modulation units which in response to an optical signal, modulate balanced-modified PN matrix codes into on-off pulses;
at least two or more optical filtering units which reflect the on-off pulses received from the optical modulation units by wavelength and encrypt into a wavelength located in a predetermined chip time; and
at least two or more optical circulators which are connected to the optical modulation units and the optical filtering units, and perform a wavelength/time selection function for the on-off pulses.

7. The encoding apparatus of claim 6, wherein the balanced-modified PN matrix codes are divided into a plurality of subgroups according to a wavelength hopping pattern, and each of the subgroups comprises a plurality of two-dimensional matrix vectors, and in each of the matrix vectors, each row vector indicates a time domain encryption pattern and each column vector indicates a wavelength domain encryption pattern.

8. The encoding apparatus of claim 7, wherein in the balanced-modified PN matrix codes, each element of the two-dimensional matrix vectors is calculated by performing an inverse-exclusive OR operation of a pair of a first modified PN code with a length of M and a second modified PN code with a length of N, and a chip-time-shift version of the pair.

9. The encoding apparatus of claim 8, wherein the first and second modified PN codes are generated by adding stuff chip 0 in a random position so that the number of 1's is the same as the number of 0's.

10. The encoding apparatus of claim 6, wherein the optical filtering unit is a fiber Bragg grating with a plurality of optical filters.

11. The encoding apparatus of claim 10, wherein the plurality of optical filters are arranged at time delay intervals of τ/2, and generate pulses corresponding to a plurality of chip times.

12. The encoding apparatus of claim 10, wherein the plurality of optical filters perform wavelength reflection complementary to each others and remove interference of optical output data between users.

13. The encoding apparatus of claim 7, wherein the encoding apparatus performs encoding by using at least two or more balanced-modified PN matrix codes belonging to different subgroups.

14. The encoding apparatus of claim 7, wherein the encoding apparatus selects two balanced-modified PN matrix codes having less interference among the plurality of balanced-modified PN matrix codes belonging to each of the subgroups, and performs encoding, and the encoded data is decoded by using a predetermined threshold in a reception end.

15. A decoding apparatus of a two-dimensional wavelength/time optical CDMA system adopting balanced-modified PN matrix codes, the decoding apparatus comprising:
a wavelength multiplexing unit which multiplexes encoded balanced-modified PN matrix codes by wavelength;
a delay unit which delays the codes multiplexed by wavelength, for a predetermined time period; and
a photo detecting unit which performs differential detection or balanced detection for the optical power of the codes input from the delay unit, and decodes the codes into the original balanced-modified PN matrix code before the encoding.

16. The decoding apparatus of claim 15, wherein the wavelength multiplexing unit is an arrayed-waveguide grating (AWG).

17. The decoding apparatus of claim 15, wherein the time delay unit comprises a plurality of delay lines which are connected between the wavelength multiplexing unit and the photo detecting unit, and delay the codes multiplexed by wavelength for a predetermined time period.

18. The decoding apparatus of claim 17, wherein the photo detecting unit comprises a first and second photo detectors that perform differential detection or balanced detection for the codes input from the time delay lines.

19. The decoding apparatus of claim 18, wherein each of the time delay lines transfers the code to the first photo detector if a code allocated to the time delay line is 1, and transfers the code to the second photo detector if a code allocated to the time delay line is 0.

20. A decoding apparatus of a two-dimensional wavelength/time optical CDMA system adopting balanced-modified PN matrix codes, the decoding apparatus comprising:
a first and second optical filtering units that multiplex encoded balanced-modified PN matrix codes by wavelength;
a first and second circulators that are connected to the first and second optical filtering units and performs a wavelength/time selection function for the codes; and
a photo detecting unit which performs differential detection or balanced detection for the optical power of the codes input from the first and second optical filtering units, and decodes the codes into the original balanced-modified PN matrix code before the encoding.

21. The decoding apparatus of any one of claims 15 and 20, wherein the balanced-modified PN matrix codes are divided into a plurality of subgroups according to a wavelength hopping pattern, and each of the subgroups comprises a plurality of two-dimensional matrix vectors, and in each of the matrix vectors, each row vector indicates a time domain encryption pattern and each column vector indicates a wavelength domain encryption pattern.

22. The decoding apparatus of claim 21, wherein in the balanced-modified PN matrix codes, each element of the two-dimensional matrix vectors is calculated by performing an inverse-exclusive OR operation of a pair of a first modified PN code with a length of M and a second modified PN code with a length of N, and a chip-time-shift version of the pair.

23. The decoding apparatus of claim 22, wherein the first and second modified PN codes are generated by adding stuff chip 0 in a random position so that the number of 1's is the same as the number of 0's.

24. The decoding apparatus of claim 20, wherein each of the first and second optical filtering units is a fiber Bragg grating with a plurality of optical filters.

25. The decoding apparatus of claim 24, wherein the plurality of optical filters are arranged at time delay intervals of τ/2, and generate pulses corresponding to a plurality of chip times.

26. The decoding apparatus of claim 24, wherein the plurality of optical filters perform wavelength reflection complementary to each others and remove interference of optical output data between users.

27. The decoding apparatus of claim 20, wherein the photo detecting unit comprises a first and second photo detectors that performs differential detection or balanced detection for the codes input from the first and second optical filtering units.

28. The decoding apparatus of any one of claims 18 and 27, wherein if the code input from the photo detecting unit is the code of the user, the differential detection result of the first and second photo detectors exceeds a predetermined threshold and the code is transited to on-state, and if the code input from the photo detecting unit is the code of other users, the codes are symmetrically input to the first and second photo detectors and the code is transited to off-state.

29. The decoding apparatus of claim 20, further comprising:
an encoding unit which performs encoding by sharing any one of the first and second optical filtering unit.

30. The decoding apparatus of claim 29, wherein the encoding unit comprises:
an optical modulation unit which in response to an optical signal, modulates balanced-modified PN matrix codes into on-off pulses and transmits the pulses to the shared optical filtering unit;
an optical circulator which is connected to the optical modulation unit and the optical filtering unit, and performs a wavelength/time selection function for the on-off pulses; and
a switch which selectively connects the encoding unit to any one of the first and second optical filtering units.
